(19) United States
(12) Patent Application Publication
(10) Pub. No.: US 2006/0100896 A1
(43) Pub. Date: May 11, 2006

(54) Web based restaurant management

(76) Inventors: Jesse M. Lahey, Perrysburg, OH (US); Martin G. Lahey, Toledo, OH (US)

Correspondence Address: Jesse M. Lahey, Suite 55, 134 W. South Boundary Street, Perrysburg, OH, 43551, US

(21) Appl. No.: 11/269,673

(22) Filed: Nov. 9, 2005

Related U.S. Application Data
(60) Provisional application No. 60/626,444, filed on Nov. 10, 2004.

(51) Int. Cl. G06Q 99/00

(52) U.S. Cl. 705/1

(57) ABSTRACT

A method and system for providing an online marketplace for registered buyers making frequently recurring purchases of multiple products or services simultaneously from multiple sellers is described. The invention is particularly useful for smaller companies that purchase a large number of different items on a weekly, twice-weekly, or other frequent basis.

### RELATED APPLICATIONS

This application claims priority under 35 U.S.C. §119 based on U.S. Provisional Application No. 60/626,444, filed Nov. 10, 2004, titled “WEB BASED RESTAURANT MANAGEMENT,” the entire disclosure of which is incorporated herein by reference.

### BACKGROUND

How an Online Marketplace Differs from Traditional Electronic Commerce

Various Internet services currently are available that provide online marketplaces allowing multiple sellers to conduct business with multiple buyers. Online marketplaces offer significant efficiencies for both sellers and buyers over traditional electronic commerce, typified by the single-seller catalog or “shopping cart” (for example, landsend.com for clothing or foodservicedirect.com for restaurant bulk foods and supplies).

Some of the notable advantages of online marketplaces for buyers are 1) the ability to easily compare and/or negotiate pricing from multiple sellers, and 2) the convenience and efficiency of placing and tracking orders through a single system. Some of the notable advantages for sellers are 1) easier, less expensive introduction to potential new customers, and 2) cost efficiencies and improved accuracy from replacing manual Order Systems with self-service systems.

Current Types of Online Marketplaces

Among current online marketplaces, the best known are consumer-oriented auction and reverse-auction sites, such as eBay and Priceline. Another popular consumer marketplace type is a search engine that allows a user to search for a single product or service among either several existing online catalogs (for example, Shopping.com) or a comprehensive catalog to which registered vendors submit their product or service information (for example, industry-specific solutions such as Travelocity.com or general-product solutions such as Half.com and Froogle.com). All known consumer online marketplaces support comparisons and purchases of only one product or service at a time—for example, the consumer can use Travelocity to find and purchase the best deal on four airline tickets to Miami.

In the business-to-business (B2B) arena, online marketplaces generally fall into one of the following three types:

Online exchanges, where brokers buy and sell standardized goods or services within a specific industry. Online exchanges include open exchanges available to all registered buyers in an industry and private exchanges for specific buyers within an industry. As an example of an open exchange, IMX.com allows mortgage brokers to post loans on behalf of their customers; once lenders across the country submit rates and fees for each loan, the broker can compare the lender bids, lock rates, and receive immediate confirmation. In a typical private exchange, a manufacturer may categorize and normalize data from multiple sellers and import the data into a single catalog. The manufacturer will then use the catalog to identify sellers of a specific product or service and take various actions such as 1) placing an order of the product or service from a selected seller, 2) negotiating a contract for the product with a selected seller, or 3) holding a reverse auction for the product or service. All known exchanges support comparisons and purchases of only one product or service at a time.

Sourcing solutions, which primarily include reverse-auction and Request for Quotation (RFQ) software and Web sites (for example, hedgehog.com and foodservicecentral.com). Sourcing solutions help a buyer select a seller and enter into an agreement to buy products/services at negotiated prices over a fixed period of time. These typically require the user to create an RFQ for a single product/service to be provided based on a specified quantity and/or contract period, and then invite sellers to provide a quotation. For example, the buyer may request per-case pricing to supply 20 cases of gaskets each week for a one-year period. With an RFQ Web site, the sellers submit their quotations for the product/service within the specified deadline. With reverse auctions, the sellers participate in a fixed duration bidding event and may submit revised bids to determine which seller will provide the product/service for the lowest cost.

Large vertically integrated purchasing systems or enterprise resource planning systems that incorporate a reverse-auction or RFQ component (for example, Ariba Technologies and CrunchTime! Information Systems). These systems are typically used by large manufacturers, restaurant chains, and retail chains for supply chain management. For example, a restaurant chain's corporate headquarters may use the reverse-auction or RFQ to negotiate a one-year contract with a seller to buy various products at fixed prices. The chain's restaurant units will then use the system to request replenishment products as needed from corporate headquarters.

Need for a New Type of Online Marketplace

Currently, there is no marketplace suited to smaller companies purchasing a moderate to large number of different products and/or services, many of which may be commodities or closely comparable products or services, on a weekly or other frequent basis. For purposes of this discussion, companies fitting this profile are referred to hereinafter as independent buyers (IBs). Some nonlimiting examples of IBs are independent restaurant companies, independent grocery companies, independent hardware and other retail companies, and independent general contracting companies, although any independent company with the need to purchase a moderate to large number of different products and/or services on a frequent basis will find the invention disclosed herein useful. Moreover, both individuals as well as large chain-like companies may also find the invention disclosed herein useful to meet certain needs, and the disclosure of the invention, while directed to IBs, is not intended to exclude use by individuals or large chain-like companies.

To further explain one of the examples noted above, an independent restaurant company is defined as a restaurant company other than a restaurant chain. A restaurant chain is a set of related restaurants, typically with the same name in many different locations, either under shared corporate ownership or franchising agreements. Typically, a restaurant chain includes a large number of restaurants built to a standard format and offers a standard menu. Due to their size and standardization, restaurant chains generally have vertically integrated purchasing systems and are able to take advantage of one of the existing marketplace types described above. An independent restaurant company may also have multiple restaurants but does not have sufficient mass to take advantage of vertical integration. The sellers who supply the food, paper, chemical, and equipment products used by independent restaurant companies include national, regional, and local wholesale foodservice distributors, as well as local providers of groceries or specialty items.

To further explain another example noted above, an independent grocery company is defined as a reseller of food, beverages, and other consumable products other than a grocery chain. As with a restaurant chain, a grocery chain typically includes a large number of grocery stores, with a standard selection of products, has a vertically integrated purchasing system, and is able to take advantage of one of the existing marketplace types described above. Independent grocery companies, which include “ma and pa” or “corner” grocery stores, natural food stores, convenience or “carry out” stores, public market vendors, and other types of stores, typically do not have sufficient mass to take advantage of vertical integration. The sellers who supply the grocery, paper, chemical, and equipment products used by independent grocery companies include national, regional, and local wholesale grocery distributors, as well as local providers of produce, dairy, or specialty items.

Currently, because no suitable online marketplace currently exists, the typical IB is not using an online marketplace of any type to purchase products or services. Instead, each time the company purchases products or services (which typically occurs frequently, such as, for example, on a weekly or twice-weekly basis), the IB must manually gather pricing information for each product or service separately from each seller via a face-to-face meeting with a seller representative, a phone call to the seller, or the seller's online catalog if available. The IB manager must then manually compare pricing from multiple sellers. Once the IB manager selects the seller for each product or service, the IB then must place an order separately for each seller via a face-to-face meeting with a seller representative, a phone call to the seller, the seller's online catalog if available, or a fax to the seller. In fact, many IBs are unable to spend the time necessary to complete each of these steps on a regular basis. Therefore, although seller prices change frequently (for example, on a weekly basis), many IBs seldom gather pricing information, and simply order from the same sellers they had previously selected for each product or service.

There are at least four reasons why the existing marketplace types do not meet IB needs, and generally are not being used by IBs:

All known online exchanges support the purchase of one product or service at a time (for example, a home mortgage or electricity). The potential cost savings would not justify an IB spending the time on a frequent basis to use an exchange to manage the purchase of hundreds of items, one item at a time. Furthermore, for many types of IBs (including the examples of independent restaurant, grocery, and retail companies), even if an IB could justify the time, there are no known online exchanges employing a taxonomy that would categorize the relevant products and services appropriately to provide for meaningful comparisons.

All known reverse-auctions and RFQ solutions support one product, service, or contract at a time. An IB could conceivably prepare a list of all items and quantities it will need for a given week. The IB could then use an existing system such as one of the websites maintained by vertmarkets.com to send the RFQ to any sellers registered to use the system. The result would be a single contract for the purchase of the entire week's order. This scenario is unlikely and, in fact, the websites of vertmarkets.com do not appear to be well utilized by IBs. The reasons are that 1) it would be extremely time-consuming for an IB to prepare and evaluate RFQs for hundreds of items on a frequent basis and for sellers to provide such quotations, and 2) each seller typically can only fulfill certain segments of an IB's total order at competitive prices, so the IB would not be receiving optimum pricing by assuming a single seller should fulfill the entire order.

IBs order specific products or services in volumes that are too low for sellers to be willing to negotiate a fixed price for a certain time period. If this were not the case, an IB could use a reverse-auction, RFQ, or vertically integrated purchasing system to negotiate such a contract for each needed item (for example, a six-month contract for cans of diced tomatoes at the fixed price of $12 per case).

Many larger companies can predict their supply needs for a six-month or 12-month period. If IBs could do so, they could possibly use a reverse-auction or RFQ marketplace to negotiate the purchase of a large quantity of each non-perishable item and simply store the items until used. However, due to the low margins of the typical IB and the expense of warehousing products, this is not feasible for the typical IB. Furthermore, some types of IBs, such as restaurants, are confronted by the unpredictable nature of the food and entertainment business, making it difficult to predict supply needs for such an extended period of time.

Attributes Useful in the New Marketplace Type

For a marketplace to be useful to IBs and their sellers, it may have some or all of the following attributes, among others:

Categorized and normalized product/service and pricing data from each major seller available within the IB's geographic service area;

Ability to view up-to-date pricing from sellers without the need to prepare an RFQ;

Option to import re-order information from the customer's accounting or inventory software;

Ability to save certain items and related quantities to an order template to facilitate future orders;

Identification of items available from multiple sellers that are identical or comparable;

Automatic pricing comparison in the order template with the identical or comparable item, with either a notification to the buyer or an automatic item substitution when an identical/comparable item with lower per-unit pricing is available;

Ability to review and manage orders of all items at the same time, with simultaneous submission of the prepared order to all sellers;

Available product or service search feature;

Ability for seller representative to immediately offer lower pricing on one or more items in response to negotiation from IB;

Option for IB to request bids on a reverse-auction basis for any subset of items in the total order at designated quantities;

Records of past orders available for a period of time;

Ability for IB to record whether items are received; and

Option to export received item quantities for importing into IB's accounting or inventory software.

### SUMMARY

An aspect of the invention is directed to a method and system for providing tools that allow a buyer to simultaneously compare and order multiple products, multiple services, or both, made available from multiple sellers.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a diagram illustrating an exemplary networked system 100 that includes an order system consistent with aspects of the invention;

FIG. 2 is an exemplary diagram of a client or server computing device;

FIG. 3 is an illustration of an exemplary graphical user interface that may be displayed to an Independent Buyer (IB) using the Catalog page;

FIG. 4 is an illustration of an option allowing the IB to view additional details about a selected item when a hyperlink is clicked;

FIG. 5 is an illustration of an exemplary graphical user interface that may be displayed to an IB using the Favorites page;

FIG. 6 is an illustration of an exemplary graphical user interface that may be displayed to an IB using the Comparison page;

FIG. 7 is an illustration of an exemplary graphical user interface that may be displayed to an IB using the Product Search;

FIG. 8 is an illustration of an exemplary graphical user interface that may be displayed to an IB using the Shopping Cart page;

FIG. 9 is an illustration of an exemplary graphical user interface that may be displayed to an IB when the IB selects an option to review the sum of prices of all items in the Shopping Cart subtotaled by item category;

FIG. 10 is an illustration of an exemplary graphical user interface that may be displayed to an IB when the IB selects an option to review the sum of prices of all items in the Shopping Cart subtotaled by seller;

FIG. 11 is an illustration of an exemplary graphical user interface that may be displayed to an IB when the IB selects an option to review Bid Prices;

FIGS. 12-14 are illustrations of exemplary graphical user interfaces that may be displayed to an IB using the My Account page;

FIG. 15 is an illustration of an exemplary graphical user interface that may be displayed to an IB who is participating in a Buying Group; and

FIG. 16 is an illustration of an exemplary graphical user interface that may be displayed to a seller using the My Customers page.

### DETAILED DESCRIPTION

The following detailed description of the invention refers to the accompanying drawings. The detailed description does not limit the invention.

The system and method of this invention are referred to hereinafter for convenience, and not by way of limitation, as the Order System. The Order System may, for example, be embodied as software running on at least one computer, also referred to hereinafter for convenience as a server, that is bidirectionally coupled to a global data communications network, such as the Internet. Users could then gain access to the Order System over the network from local terminals, which can be PCs, workstations, wireless Internet connectivity devices such as cellular telephones and personal organizers, or by any suitable technique. One skilled in the art would also be able to establish and utilize methods for practicing this invention other than this embodiment.

For ease of explanation only, and not intending to limit the scope of the invention, one or more of the users is assumed to be an IB, and one or more of the users is assumed to be a “seller” of one or more products or services. Each IB is registered in the Order System as such, and the names of each of the IB's units (for example, an independent retail company with multiple stores) may be associated with the IB's record. A seller is registered in the Order System as such, and records of one or more seller representatives and any geographic territories may be associated with the seller's record.

The Order System may require that, for the IB and seller to conduct business with each other, either the IB or seller add the other to their “relationship list.” This list specifies which IBs and sellers in the Order System are available to conduct business with each other based on geography or other factors. In addition, both the IB and seller may have the option of excluding the other from their relationship list. Thus, the Order System may require that both parties agree to conduct business with each other in order to interact using the Order System.

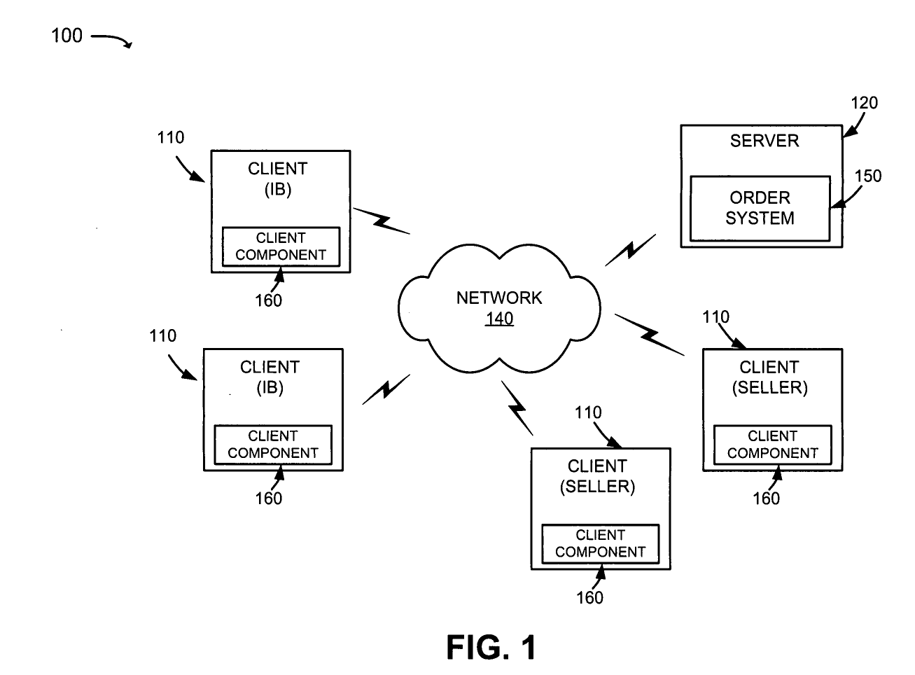

FIG. 1 is a diagram illustrating an exemplary networked system 100 that includes the Order System. System 100 may include multiple clients 110 and a server 120 via a network 140. Network 140 may include a local area network (LAN), a wide area network (WAN), a telephone network, such as the Public Switched Telephone Network (PSTN), an intranet, the Internet, or a combination of networks. Four clients 110 and one server 120 have been illustrated as connected to network 140 for simplicity. In practice, there may be more clients and/or servers. Also, in some instances, a client may perform one or more functions of a server and a server may perform one or more functions of a client.

Two of clients 110 are labeled as IBs. These clients may correspond to client devices associated with IBs. Two other of clients 110 are labeled as Seller. These client devices may be associated with Sellers.

A client 110 may include a device such as a wireless telephone, a personal computer, a personal digital assistant (PDA), a laptop, or another type of computation or communication device, a thread or process running on one of these devices, and/or an object executable by one of these devices. Server 120 may include a server device that implements the Order System 150. Clients 110 and server 120 may connect to network 140 via wired, wireless, or optical connections. Clients 110 may interact with Order System 150 as described herein. The interaction with Order System 150 may be via a client component 160. Client component 160 may include, for example, a web browser program or a program specifically designed to interact with Order System 150. Client component 160 may be implemented differently for the IBs and the Sellers.

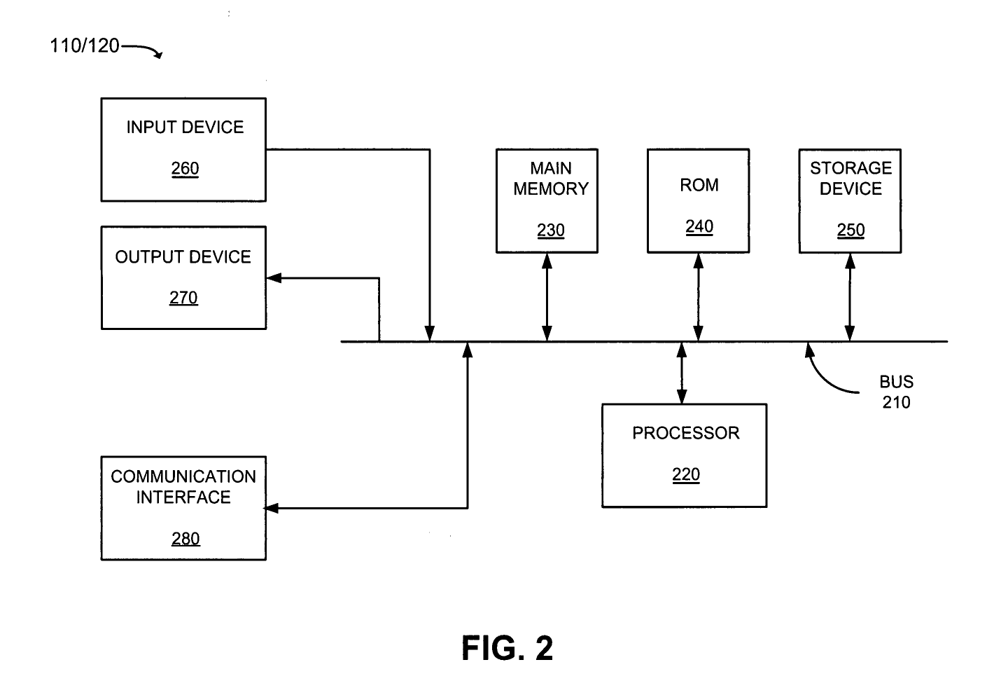

FIG. 2 is an exemplary diagram of a client 110 or server 120. Client/server 110/120 may include a bus 210, a processor 220, a main memory 230, a read only memory (ROM) 240, a storage device 250, an input device 260, an output device 270, and a communication interface 280. Bus 210 may include conductors that permit communication among the components of client/server 110/120.

Processor 220 may include conventional processors, microprocessors, or processing logic that interpret and execute instructions. Main memory 230 may include a random access memory (RAM) or another type of dynamic storage device that stores information and instructions for execution by processor 220. ROM 240 may include a conventional ROM device or another type of static storage device that stores static information and instructions for use by processor 220. Storage device 250 may include a magnetic, optical, and/or other recording medium and its corresponding drive.

Input device 260 may include one or more conventional mechanisms that permit a user to input information to client/server 110/120, such as a keyboard, a mouse, a pen, voice recognition and/or biometric mechanisms, etc. Output device 270 may include one or more conventional mechanisms that output information to the user, including a display, a printer, a speaker, etc. Communication interface 280 may include any transceiver-like mechanism that enables client/server 110/120 to communicate with other devices and/or systems. For example, communication interface 280 may include mechanisms for communicating with another device or system via a network, such as network 140.

Server 120, consistent with the principles of the invention, may implement Order System 150. Order System 150 may be stored in a computer-readable medium, such as memory 230. A computer-readable medium may be defined as one or more physical or logical memory devices and/or carrier waves. The software instructions defining Order System 150 may be read into memory 230 from another computer-readable medium, such as data storage device 250, or from another device via communication interface 280. The software instructions contained in memory 230 may cause processor 220 to perform processes that will be described later. Alternatively, hardwired circuitry or other logic may be used in place of, or in combination with, software instructions to implement processes consistent with the invention. Thus, implementations consistent with the principles of the invention are not limited to any specific combination of hardware circuitry and software.

IB Features

In one embodiment, upon logging into the Order System, the IB may, for example, select the name(s) of its unit(s) for which it is purchasing. In another embodiment, if the IB has only a single unit, the IB may not have the option to select a unit. In another embodiment, an IB with multiple units may have the option to purchase for all of its units simultaneously, and may do so by, for example, selecting “all” for its unit. In yet another embodiment, the IB may delegate one or more units to one or more individuals, such as, for example, purchasing managers; in this example, the purchasing managers would be able to log in and utilize the system for the appropriate unit(s), and the IB would be able to utilize the system for some or all units.

Once the unit or units has been determined, the IB may then proceed to a set of software tools referred to hereinafter for ease of reference only as the IB Console. The IB Console may be provided by Order System 150 and/or client component 160.

One tool that may be available within the IB Console is referred to hereinafter for ease of reference only as the Catalog page. This can be a listing of all products and/or services (referred to hereinafter for ease of reference only as “items”) available to the IB from some or all sellers on its relationship list. In one embodiment, the Catalog page may include, for example, a matrix displaying each item's standardized name, name of the seller offering the item, brand name of the item, the price set by the seller for one case of the item, the calculated cost per standard unit based on the case price, and/or the calculated cost per standard unit based on the “each” price if available, and so on. An “each” is a single product that some wholesale distributors choose to make available for sale by breaking apart a case. In addition, an option may be available to allow the IB to view additional details about a selected item, such as, for example, configuration, number of items packed in one case, the seller's item code, the Universal Product Code (UPC), the name or description applied to the item by the seller, the price set by the seller for one “each” of the item if available, a photograph of the item if available, and so on. In one embodiment, the IB may be able to scroll and page through the complete listing on the Catalog page, utilize a menu to filter the listing based on the Order System's taxonomy (described below), and/or utilize a search engine to find items.

Included in some embodiments may be a taxonomy structure that can standardize and normalize some or all items available from the sellers. In one embodiment, one component of a taxonomy can be a standardized name and/or identification code applied to a specific item as well as to other items from some or all sellers that are comparable and are available in a similar configuration. Referred to hereinafter for ease of reference only as Comparable Items, these are products or services from one or more sellers that some IBs may choose to substitute to meet their needs. For example, some restaurant companies will purchase bottled catsup of a particular brand from any available seller; for these companies, only products that offer catsup of that brand are considered “comparable,” and only when offered in bottles (as opposed to non-similar configurations such as single-serving packets). Other restaurant companies will purchase bottled catsup of multiple brands, as long as the catsup meets certain quality and taste requirements; therefore, any such catsup in bottles may be considered “comparable.” The standardized names and/or codes may then be organized into categories and sub-categories for easy reference. For example, the same code may be applied to every item from every seller that is a case of twelve 46-ounce cans of orange juice that is made from concentrate, assuming there are no material differences in the concentration level or specific gravity. In addition, these codes may be assigned an additional identification code to allow comparisons with comparable items that are sold in a different configuration (continuing the previous example, the case of twelve 46-ounce cans of orange juice could be compared with a case of twelve 24-ounce cans of orange juice). Some embodiments may allow IBs to designate preferences on which items should be considered Comparable items; for example, a restaurant company may indicate a preference to include only catsup of a particular brand, or only orange juice configured in a case of twelve 46-ounce cans.

On the Catalog page, there may be a variety of actions the IB can take for each item. In one embodiment, one action (referred to hereinafter for ease of reference only as Add to Cart) may be to save one or more items and a designated case and/or “each” quantity to an order form, referred to hereinafter for ease of reference only as the Shopping Cart. The Shopping Cart can be similar to the shopping cart concept that is well known and widely used in electronic commerce systems. Another action in some embodiments (referred to hereinafter for ease of reference only as Add to Favorites) may be to add the items to the list of items the IB regularly purchases, referred to hereinafter for ease of reference only as the Favorites list and described below. In these embodiments, if an item is added to the Favorites list, an icon may subsequently appear on the Catalog page near the item's standardized name to identify it as an item currently listed on the Favorites list. When adding items to the Favorites list, the IB may also in some embodiments designate a case and or “each” quantity to be saved as a default quantity in order to facilitate future orders.

For the Catalog page, as well as for other tools (such as, for example, the Favorites page, Comparison page, and/or Shopping Cart page described below) that may be available within the IB Console, the IB may be able to take actions on multiple items simultaneously. For example, in one embodiment, the IB may be able to place a checkmark in a box indicating each item, enter a quantity of cases and/or a quantity of “eaches,” and then click a button that executes an action such as Add to Favorites or Add to Cart. In another embodiment, the IB may be able to select an option that adds all items on the Favorites page with the default case and/or “each” quantities (described below) to the Shopping Cart in a single step. One skilled in the art would also be able to establish and utilize methods for the IB to take actions on multiple items simultaneously other than those described in these examples.

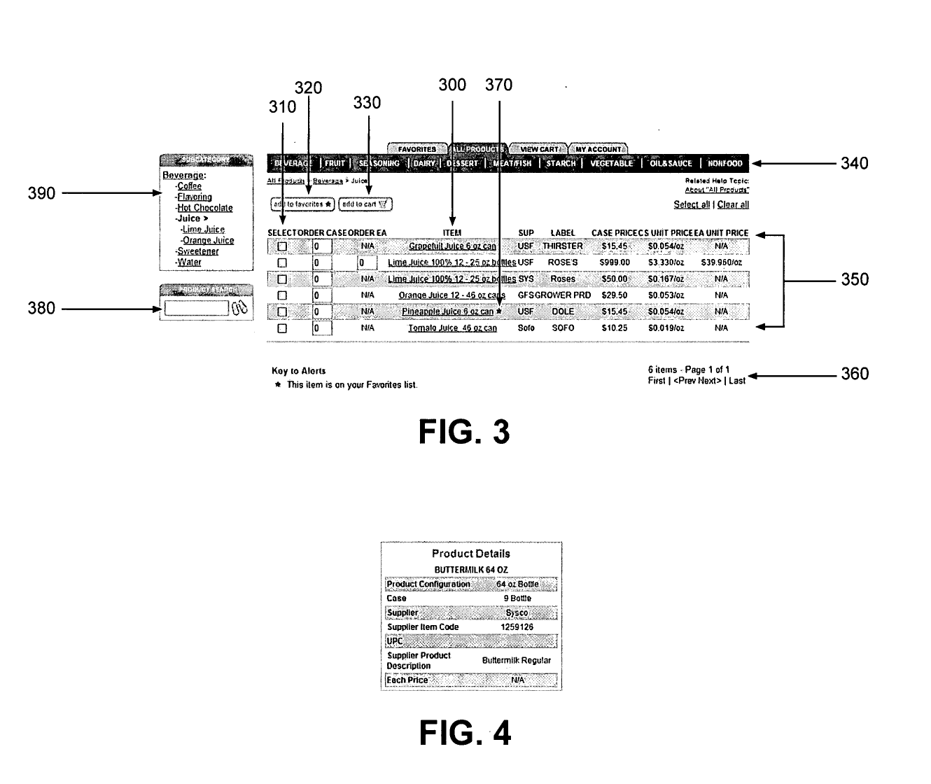

FIG. 3 is an illustration of an exemplary graphical user interface that may be displayed to an IB using the Catalog page. The figure includes a matrix 350, an option to page through the complete listing 360, a standardized name for each item 300, a display of first-level categories of the taxonomy 340, a display of the subcategories of a selected first-level category of the taxonomy 390, a search engine 380, an Add to Cart option 330, an Add to Favorites option 320, an icon identifying items currently listed on the Favorites list 370, and an option to place checkmarks in boxes to take an action on multiple items simultaneously 310. FIG. 4 is an illustration of an option allowing the IB to view additional details about a selected item when the hyperlink in 300 is clicked.

Another tool that may be available in the IB Console is referred to hereinafter for ease of reference only as the Favorites page. In one embodiment, this may be a listing of all items existing on the IB's Favorites list. The Favorites page may include a matrix displaying for these items similar information as the matrix included on the Catalog page, discussed above. In addition, this matrix can display the default quantity of cases and/or “eaches” previously saved to the Favorites list. The Favorites page can also include additional item details, as described for the Catalog page. The Favorites page can also include similar options as the Catalog page, for example, to scroll and page through the complete listing, to filter the listing based on the taxonomy, etc.

On the Favorites page, there also may be a variety of actions the IB can take. One such action may be the same Add to Cart action described above. A second possible action (referred to hereinafter for ease of reference only as Save Changes) may be to enter a different designated default quantity of cases and/or “eaches” for one or more items and re-save the records to the Favorites list. A third possible action (referred to hereinafter for ease of reference only as Remove from Favorites) may be to delete one or more items from the Favorites list.

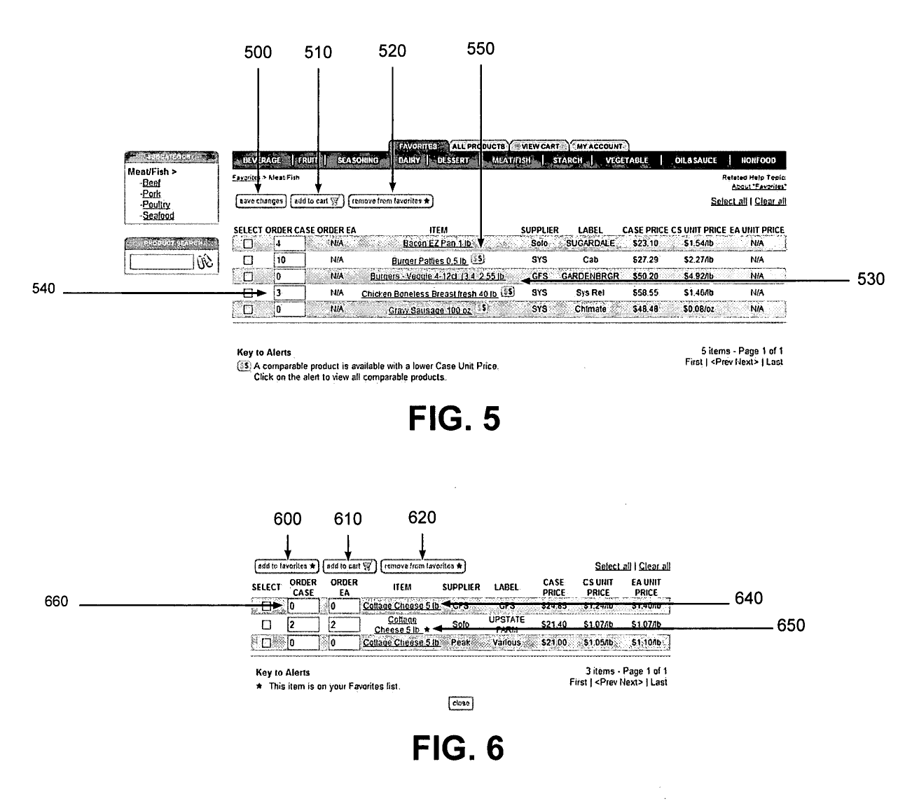

FIG. 5 is an illustration of an exemplary graphical user interface that may be displayed to an IB using the Favorites page. The figure includes many similar options as FIG. 3, including a matrix, the option to page through the complete listing, etc. In addition, the figure includes a list of items currently saved to the Favorites list 530, a display of the default quantity of cases and/or “eaches” previously saved 540, an Add to Cart option 510, a Save Changes option 500, and a Remove from Favorites option 520.

The Order System may maintain comparisons of each item based on variables such as, for example, price, quality, customer feedback ratings, repair history, and/or seller's customer service. In one embodiment, for example, one comparison may be based on the item's Per-Unit Pricing, which can be calculated, for example, by dividing the seller's price by the number of standard units (for example, ounces) provided in the item configuration. The Order System could execute an action when an item on the IB's Favorites list or Shopping Cart is less competitive than one or more Comparable Products based on one or more comparison variables, such as, for example, the variables listed above. In one embodiment, for example, for a given item the Order System could automatically substitute any Comparable Product available at a lower Per-Unit Pricing if, for example, the IB has designated its preferences for making such substitutions. In another embodiment, if an item on the IB's Favorites list has higher Per-Unit Pricing than at least one Comparable Product, the Order System could notify the IB (for example, by having an icon, referred to hereinafter for ease of reference only as the Comparison icon, appear near the item's standardized name). In this embodiment, as a result of the presence or absence of the Comparison icon, the IB may enjoy the benefit of ignoring the possibility of any Comparable Items offering a better value unless and until the icon is present.

FIG. 5 includes an illustration of a Comparison icon 550.

Another tool that may be available to the IB is referred to hereinafter for ease of reference only as the Comparison page. This page can list a selected item and its Comparable Items. The Comparison page can include a matrix that displays similar information for these items as the matrix mentioned above for the Catalog page, as well as an option to view additional item details. In addition, this matrix can display the quantity of cases and/or “eaches” for the item and any Comparable Items previously saved to the Favorites list. For all items currently on the Favorites list, an icon can appear near the item's standardized name to indicate that it is a Favorites item.

On the Comparison page, there may be a variety of actions the IB can take, such as the same Add to Cart, Add to Favorites, and Remove from Favorites actions described above. As a result of this page, the IB can easily compare the value offered by the item with those offered by Comparable Items, and can choose to save a Comparable Product to the Shopping Cart in place of the item or even replace the item on the Favorites list with a Comparable Item.

FIG. 6 is an illustration of an exemplary graphical user interface that may be displayed to an IB using the Comparison page. The figure includes many similar options as FIGS. 3 and 5, including a matrix, the option to scroll and page through the complete listing, etc. In addition, the figure includes a list that comprises a selected item and its Comparable Items 640, the quantity of cases and/or “eaches” for the item and any Comparable Items previously saved to the Favorites list 660, an icon signifying all items currently on the Favorites list 650, an Add to Cart option 610, an Add to Favorites option 600, and a Remove from Favorites option 620.

Another tool that may be available in the IB Console is referred to hereinafter for ease of reference only as the Product Search. In one embodiment, the Product Search may be similar to search engines that are well known and widely used in electronic commerce systems; for example, if the IB enters a keyword(s), the search engine may provide a listing of all items containing the keyword(s). In another embodiment, the IB can enter a keyword(s), and the Order System can display the taxonomy category for some or all items containing the keyword(s). For example, the Product Search could include hyperlinks to the location within the Catalog page or, if applicable, the Favorites page, and clicking on one of the hyperlinks would display the item within a list of items filtered at the Order System's lowest taxonomy level, that is, the level that includes the fewest number of items. As a result of this embodiment, the IB would not only be able to search for an item but also to learn the item's taxonomic category, thus reducing the need for future searches.

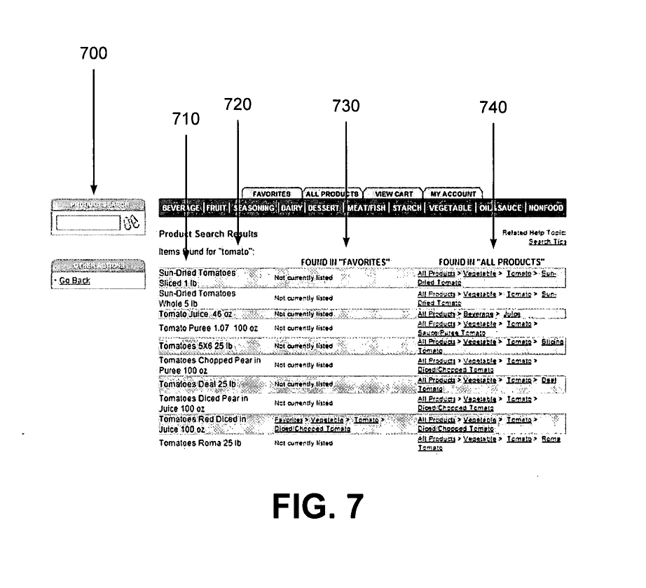

FIG. 7 is an illustration of an exemplary graphical user interface that may be displayed to an IB using the Product Search. The figure includes a field to enter a keyword(s) 700, a list of items containing the keyword 710, a display of the keyword(s) on which the current search results are based 720, the taxonomy category with a hyperlink to the Favorites page if applicable 730, and the taxonomy category with a hyperlink to the Catalog page 740.

Another tool that may be available within the IB Console is referred to hereinafter for ease of reference only as the Shopping Cart page. This may be a listing of some or all items existing in the IB's Shopping Cart. The Shopping Cart page can include a matrix displaying, for example, similar information as the matrix discussed above for the Catalog page, as well as additional item details. In addition, this matrix can display the quantity of cases and/or “eaches” the IB may be intending to purchase for each item. The Shopping Cart could also provide item comparison information and features such as those described above. The Shopping Cart page can also include similar options as the Catalog page, for example, to scroll and page through the complete listing, to filter the listing based on the taxonomy, etc.

On the Shopping Cart page, there also may be a variety of actions the IB can take. For example, in one embodiment, one such action may be to change the order quantity of cases and “eaches” for one or more items and re-save the records to the Shopping Cart. A second possible action may be to remove selected items from the Shopping Cart. A third possible action may be to review the prices of all cases and “eaches” in the Shopping Cart subtotaled by seller. A fourth possible action may be to review the prices of all cases and “eaches” in the Shopping Cart subtotaled by item category. A fifth possible action may be to request negotiated pricing, as described below, from one or more sellers. A sixth possible action may be to review Bid Prices (defined below) from sellers, as well as to view the overall effect that accepting the Bid Prices would have on the total price of the order. A seventh possible action may be to execute the order of some or all items with some or all sellers; this execution may be similar to one or more “check out” processes that are well known and commonly used in electronic commerce.

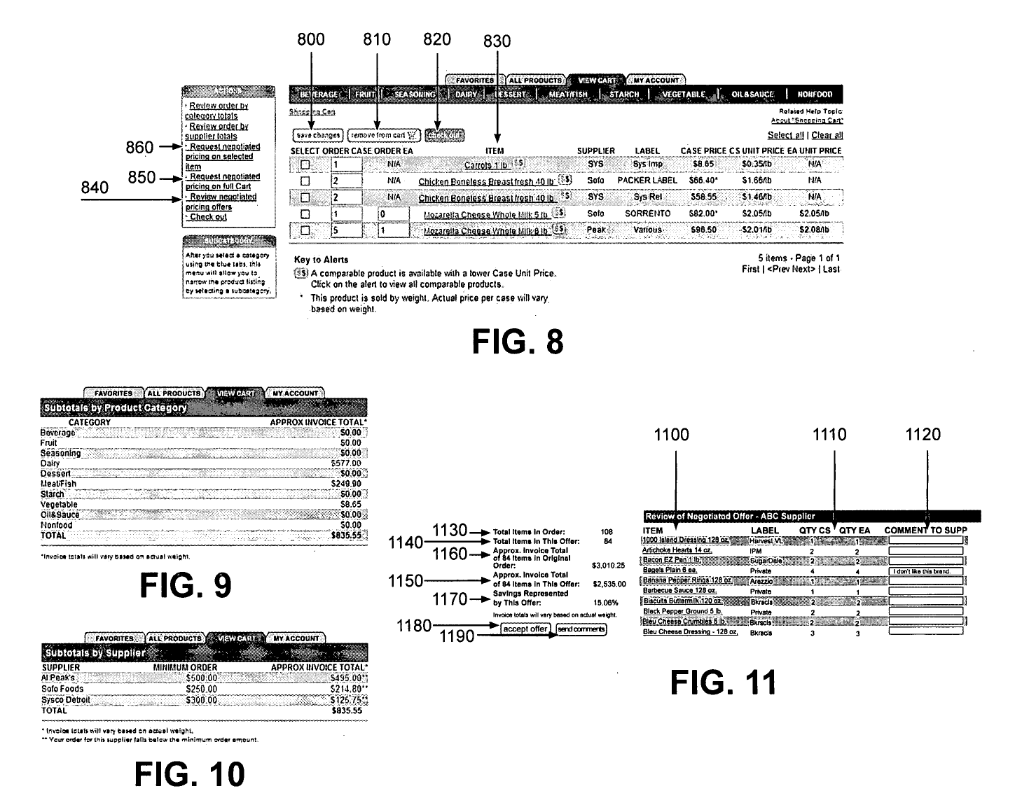

FIG. 8 is an illustration of an exemplary graphical user interface that may be displayed to an IB using the Shopping Cart page. The figure includes many similar options as FIGS. 3 and 5, such as a matrix, ability to page through items, comparison icon, etc. The figure also includes a listing of some or all items existing in the IB's Shopping Cart 830, an option to change quantities of items and re-save the records 800, an option to remove selected items from the Shopping Cart 810, an option to request negotiated pricing from one or more sellers for a selected item 860 or for the entire order 850, an option to review Bid Prices from sellers 840, and an option to execute the order by “checking out” 820.

FIG. 9 is an illustration of an exemplary graphical user interface that may be displayed to an IB when the IB selects an option to review the sum of prices of all items in the Shopping Cart subtotaled by item category. FIG. 10 is an illustration of an exemplary graphical user interface that may be displayed to an IB when the IB selects an option to review the sum of prices of all items in the Shopping Cart subtotaled by seller.

FIG. 11 is an illustration of an exemplary graphical user interface that may be displayed to an IB when the IB selects an option to review Bid Prices. The figure includes a list of items that the seller is able to supply that are identical or Comparable to items in the IB's Shopping Cart 1100, a display of the quantity of cases and “eaches” included in the offer 1110, the ability for the IB to make comments to the seller about specific products 1120, a display of the total number of items in the IB's Shopping Cart 1130, a display of the total number of items in the seller's offer 1140, a display of the total cost of the offer 1150, a display of the total cost represented by the same items or Comparable Items in, the Shopping Cart 1160, a display of the savings represented by accepting the offer 1170, the ability to accept the offer 1180, and the ability to send the entered comments to the supplier 1190.

Another tool that may be available in the IB Console is referred to hereinafter for ease of reference only as the My Account page. In one embodiment, this may allow IBs to review past order information, which may include, for example, an order number, the time and/or date the order was submitted, the sellers represented in the order, the order total price (possibly subtotaled by seller), etc. Due to irregularities in some types of products or services, such as meat sold by the pound or lumber sold by the foot, some price totals may need to represent estimated totals that will not be finalized until the seller(s) fulfills the order. The past order information could also include certain details about each item included in the order, such as, for example, the item name and/or description assigned by the seller, any code assigned to the item by the seller, the price at which the item was ordered, the quantity of the item ordered, the cost of ordering the specified quantity of the item, etc. In one embodiment, the My Account page may also allow the IB to designate a preference to participate in one or more groups, referred to hereinafter for ease of reference only as Buying Groups and described below. The My Account page may also include other features, for example, to allow the IB to change its password or other user information, to set preferences regarding receiving communications such as email notifications that may be available from the Order System, to set preferences for which sellers should or should not be included on its relationship list, etc.

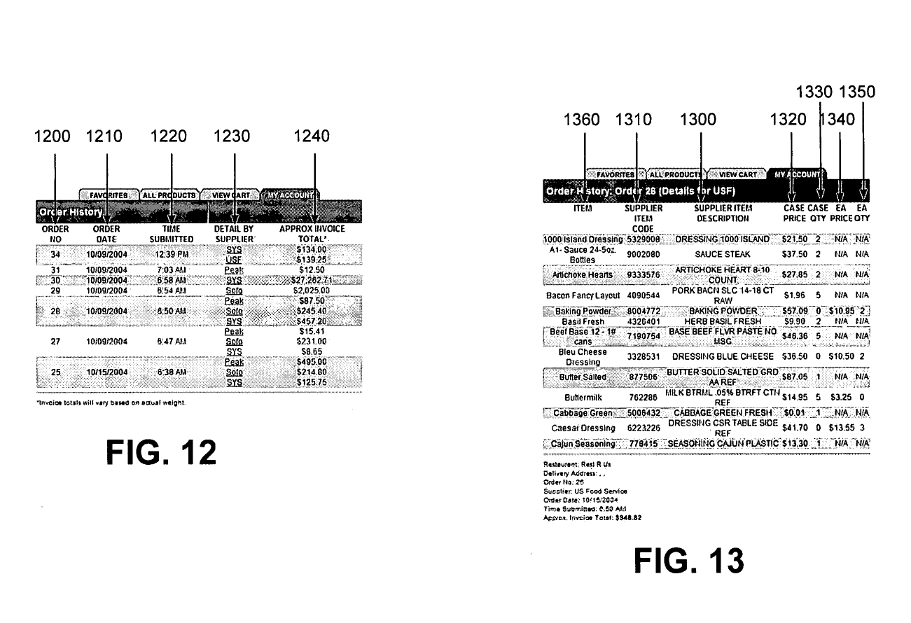

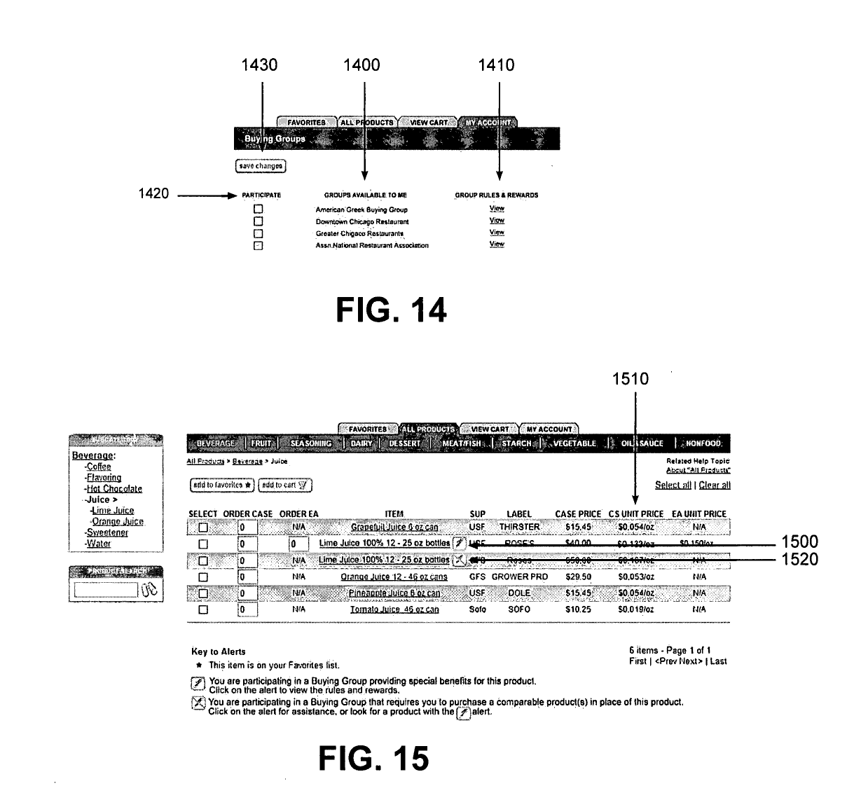

FIGS. 12-14 are illustrations of exemplary graphical user interfaces that may be displayed to an IB using the My Account page. FIG. 12 displays past order information, including each order's order number 1200, order date 1210, the time the order was submitted 1220, the sellers represented in the order 1230, and the total price of each seller's portion of the order 1240. FIG. 13 displays information about each item included in a selected order, including the item name assigned by the seller 1300, the code assigned to the item by the seller 1310, the case price at which the item was ordered 1320, the quantity of cases ordered 1330, the “each” price at which the item was ordered 1340, the quantity of “eaches” ordered 1350, and the name assigned to the item by the Order System 1360. FIG. 14 displays a list of Buying Groups available to the buyer 1400, a hyperlink to a page displaying the rules for participating in each Buying Group and the benefits thereof 1410, an option to designate a preference to participate in one or more buying groups 1420, and a button to save the preference 1430.

A Buying Group is a group of IBs that elect to join orders in one or more ways in order to receive volume discount pricing, special payment terms, improved customer service, lower order minimums, or other advantages from one or more sellers. In other words, a Buying Group may help IBs leverage their combined buying power to receive similar advantages to those enjoyed by large chainlike companies. There are several types of Buying Groups that could be formed. In one embodiment, for example, a Buying Group may be established for IBs in one or more industries, or even subsets of industries, located within a certain geography. In other embodiment, a Buying Group may be established for IBs in one or more industries belonging to one or more trade associations.

There are also several ways that orders could be joined. In one embodiment, for example, sellers may be able to offer to a Buying Group a discounted price for a specific item or set of items based on the requirement that if the seller's item or set of items provides the lowest price for a specified time period, the Order System will allow members of the Buying Group to order that seller's item(s) but prevent them from ordering any Comparable Items of the item(s). In another embodiment, sellers may receive summary information about the items and quantities on the Favorites lists of the IBs participating in the Buying Group; sellers may then offer special pricing to the Buying Group, and the special pricing may be displayed when the IB views the Favorites page and/or the Shopping Cart page. In another embodiment, Buying Group order previews may be combined when IBs request Bid Prices, and the Bid Prices offered by sellers may be contingent upon a certain level of acceptance or minimum orders by IBs participating in the Buying Group. One skilled in the art would also be able to establish and utilize other methods for joining IB orders or otherwise encouraging sellers to offer improved pricing, payment terms, customer service, or other advantages to the Buying Group other than those described in these examples.

FIG. 15 is an illustration of an exemplary graphical user interface that may be displayed to an IB who is participating in such a Buying Group. This illustration of the Catalog page includes an icon 1500, which indicates that a certain product offered by a certain seller has been designated in the Buying Group's agreement as one that should only be ordered from the designated seller, the discounted pricing offered for the product 1510, and an icon on Comparable products indicating that the buyer has agreed to not order such products 1520.

The IB Console may also provide tools to send information to or receive information from the IB's information system. For example, many IBs utilize small business accounting or inventory software that allows them to track their inventory, including the points at which the IBs need to purchase items. In one embodiment, the IB Console may allow the IB to import a file exported by the accounting software containing information such as, for example, which items to order and the case and/or “each” quantities. Once sellers have fulfilled the order, the IB Console may allow the IB to record the specific items and quantities that have been received (to take into account back-ordering and products such as produce that may be sold in irregular quantities) and then export a file that can be imported by the accounting or inventory software. In other embodiment, these files are automatically imported and exported on a regular basis. One skilled in the art would be able to establish and utilize various methods for importing such files from and exporting such files to the various types of accounting or inventory software commonly used by IBs.

Seller Features

In one embodiment, upon logging into the Order System, the seller may, for example, select the name of the seller company's division, geographic region, or other entity within the seller's company. In another embodiment, if the seller company has only a single entity, the seller may not have the option to select an entity. In another embodiment, a seller with multiple entities may have the option to use the Order System for all of its entities simultaneously, and may do so by, for example, selecting “all” for its entity. In yet another embodiment, the seller may delegate one or more entities to one or more individuals, such as, for example, sales representatives; in this example, the sales representatives would be able to log in and utilize the system for only the appropriate entities, and the seller would be able to utilize the system for some or all entities.

Once the entity or entities is determined, the seller may proceed to a set of tools referred to hereinafter for ease of reference only as the Seller Console.

One tool that may be available within the Seller Console is referred to hereinafter for ease of reference only as the Seller's My Account page. The Seller's My Account page may include features such as, for example, the ability to change its password or other user information, to set preferences regarding receiving communications such as email notifications that may be available from the Order System, etc.

Another tool that may be available within the Seller Console is referred to hereinafter for ease of reference only as the My Customers page. On the My Customers page, there may be a variety of actions the seller can take. In one embodiment, for example, the seller may be able set preferences for which IBs should or should not be included on its relationship list. In one embodiment, the seller can view some or all IBs that have registered with the Order System within a certain geography, and then add or exclude various IBs from its relationship list. In another embodiment, the seller can send an electronic invitation to an IB to register with the Order System. The seller may also be able to set certain parameters for each IB, such as, for example, order deadlines, minimum order amounts, payment terms, delivery times, pricing schedules (such as, for example, a standard percentage markup or discount), etc. The seller may also be able to record certain information about some IBs, such as, for example, the name of the person at the IB who is responsible for placing orders or for receiving orders that may be delivered.

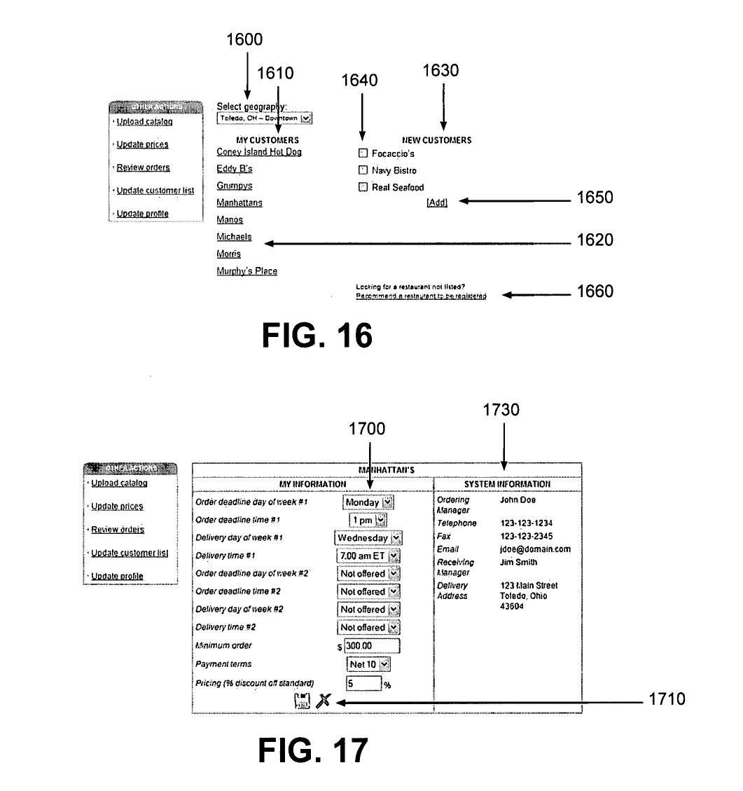

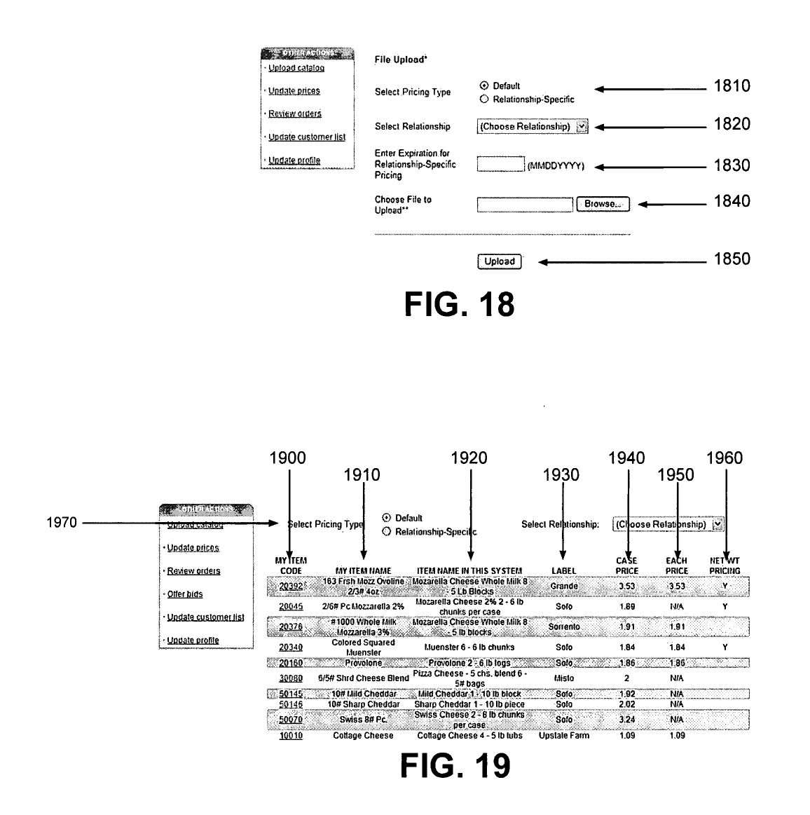

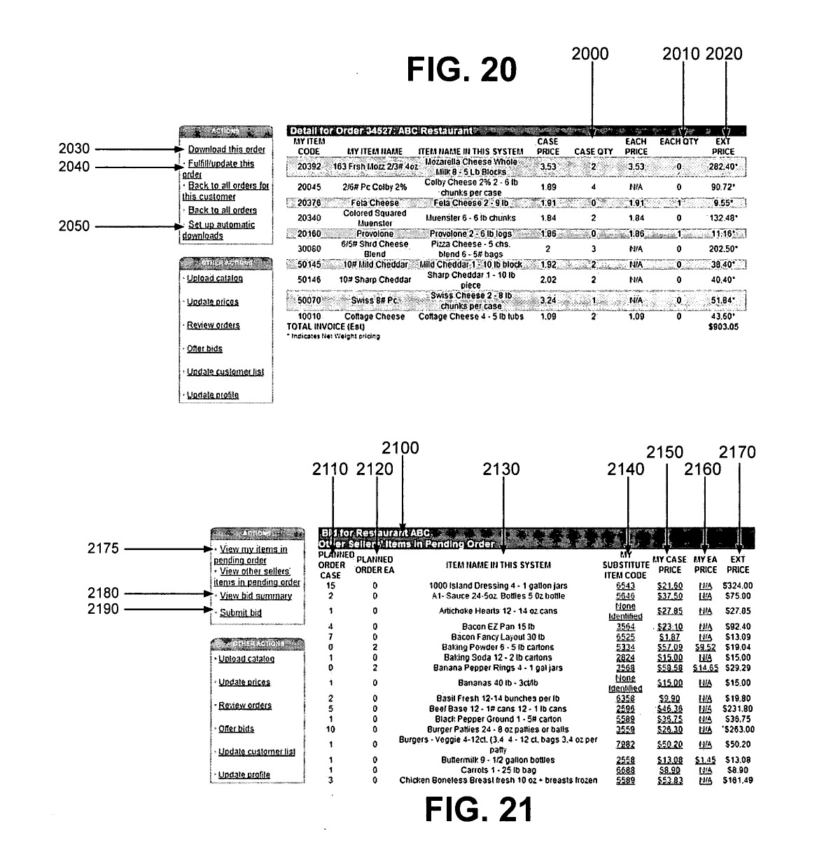

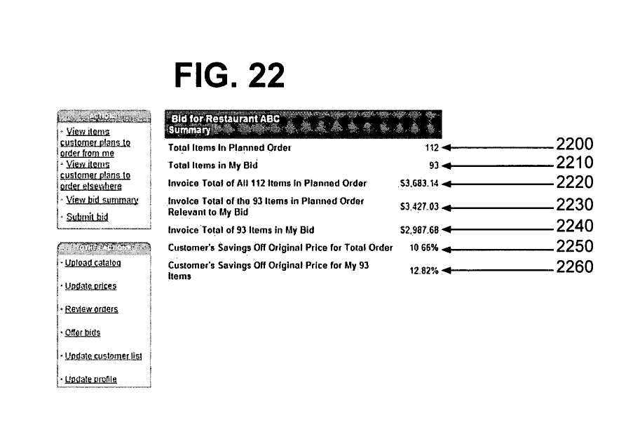

FIG. 16 is an illustration of an exemplary graphical user interface that may be displayed to a seller using the My Customers page. The figure includes an option to select a specific geography 1600, a list of buyers within that geography that the seller has previously added to its relationship list 1610, the option to click on a hyperlink in order to make changes to a buyer's parameters or other information or to remove that buyer from the relationship list 1620, a list of buyers within that geography who are registered in the Order System but not currently on the seller's relationship list 1630, the option to select buyers 1640 and add them to the relationship list 1650, and an option to suggest additional buyers within that geography that may be interested in registering in the Order System 1660. FIG. 17 is an illustration of another exemplary graphical user interface that may be displayed to a seller using the My Customers page. The figure includes a list of the existing parameters set for the IB and the ability to change the parameters using drop-down menus and text fields 1700, the ability to save or cancel the changed parameters 1710, and the ability to view information saved in the Order System by the IB 1730.

Another tool that may be available within the Seller Console is referred to hereinafter for ease of reference only as the My Items page. This page may provide the seller with one or more options for placing its item information and pricing into the Order System and for updating the information regularly. In one embodiment, for example, the seller may be able to manually enter the new or updated information onto a web page. In another embodiment, the seller may be able to upload a data file containing the new or updated information. In another embodiment, the seller may be able to establish an automated connection with the Order System; for example, the Order System may provide certain standard connection options, and if the seller selects certain options and provides certain technical information about the seller's information systems, the Order System may allow the seller's information systems to automatically send a file containing the new or updated information to the Order System on a regular basis (for example, weekly, daily, each time the seller's information changes, etc). One skilled in the art would be able to establish and utilize a variety of methods for sellers to provide their item information to the Order System. The My Items page may also allow the seller to designate some items, or some item variables (such as, for example, prices), as available to some IBs, while other items or item variables as available to other IBs. The My Items page may also allow the seller to designate whether pricing for certain items is quoted on a Net Weight Pricing basis. Net Weight pricing, typically used for produce, meat, and other items of irregular weight, means that although an item may be packaged in cases or “eaches,” the price is quoted as a per-unit-of-weight price, and the final price billed will be based on the actual weight that is delivered.

FIG. 18 is an illustration of an exemplary graphical user interface that may be displayed to a seller using the My Items page. The figure includes the ability to choose a data file to upload 1840, the ability to indicate whether the data contains information for all IBs on the seller's relationship list or contains data for a specific relationship (which may be a relationship with a specific IB, a specific IB unit, and/or a specific Buying Group) 1810 and 1820, the ability to indicate a date that the pricing reflected in the file expires 1830, and the ability to upload the file 1850. FIG. 19 is another illustration of an exemplary graphical user interface that may be displayed to a seller using the My Items page. The figure includes a list of items displaying each item code 1900, the name assigned to the item by the seller 1910, the name assigned to the item by the Order System 1920, the item's label 1930, the price per case currently in the Order System 1940, the price per “each” currently in the Order System 1950, and an indicator as to whether the item's quoted prices are based on Net Weight Pricing 1960. FIG. 19 also includes a hyperlink on the item code 1900, which the seller may click in order to change prices or other information or to delete an item. FIG. 19 also includes the ability for the seller to select whether to view and change default pricing or pricing for a specific relationship 1970, which may be a relationship with a specific IB, a specific IB unit, and/or a specific Buying Group.

Another tool that may be available within the Seller Console is referred to hereinafter for ease of reference only as the My Orders page. This page may provide the supplier with various types of information about currently pending or past orders. In one embodiment, for example, the seller may be able to view some or all past orders to the seller from some or all IBs, and possibly to review details about the orders, similar to the information that may be available on the IB's My Account page. The seller may also be able to view summary information about past orders. For example, in one embodiment, where not prevented by law or by an IB's preferences, this information could include comparison of total order dollars from an IB in a given period for the seller with total order dollars from the IB in the same period for all registered sellers, a comparison of total order dollars from some or all relevant IBs in a period with total order dollars from those IBs in the period for all registered sellers, a listing of the seller's items that are selling less frequently than Comparable Items, etc. Such comparisons would only involve aggregate information, as sellers would not be able to view details about orders from other sellers. The My Orders page may also allow the seller take certain actions regarding pending orders, such as, for example, downloading order information into the seller's information system, designate when the order has been fulfilled, designate any back-ordered items, indicate any rebate credits, etc. The My Orders page may also allow the seller to establish an automated connection with the seller's information system, for example, to allow the Order System to automatically send order information to the seller's information system. One skilled in the art would be able to establish and utilize a variety of methods for sellers to receive order information from the Order System.

FIG. 20 is an illustration of an exemplary graphical user interface that may be displayed to a seller using the My Orders page. The figure includes similar information as illustrated in FIG. 19, and it also includes the quantity of cases ordered by the IB 2000, the quantity of “eaches” ordered by the IB 2010, the price subtotal for the specified quantities of a specific item 2020, an option to download the information about this order 2030, an option to indicate which of the items have been fulfilled and which have been placed on backorder 2040, and an option to establish an automated connection as described above 2050.

In some embodiments there may be a tool within the Seller Console that can enable the seller to override its standard pricing in response to a request for negotiated pricing. For example, the seller could input alternate pricing offered to a specific IB for specific items. There are several types of alternate pricing that could be offered. In one embodiment, for example, one type of alternate pricing may be simply a lower price offered on one or more items. Referring back to FIG. 19 again, this illustration includes features that allow the seller to offer a lower price to an IB. Another type of alternate pricing is referred to hereinafter for ease of reference only as a Bid Price. Bid Prices may provide lower prices on a defined set of items that are contingent on the seller ordering some or all of the items within the set. One embodiment may allow the seller to review a list of items in a pending order from one or more IBs who may have granted access to one or more sellers. The seller may, for example, select the items to be included in the Bid Set, and indicate a total Bid Price for the full Bid Set and/or individual Bid Prices for some or all items in the Bid Set. Additional features may be included to assist the seller with determining the Bid Prices to offer. For example, in one embodiment, calculation features may be available that subtotal the seller's portion of the item list compared to the portion that may be fulfilled by other sellers, and/or that estimate sales volume and/or profit when certain items are included in a Bid Set at certain prices. In another embodiment, the list of pending order items may indicate whether Comparable Items are available from the seller, and the seller may be able to filter the list to view only items the seller is able to provide. This page may also include information about whether one or more IBs have accepted the supplier's Bid Prices. Another type of alternate pricing involves pricing offered to IBs that have elected to participate in a Buying Group. In one embodiment, for example, the seller may view the name of the Buying Group, the list of IBs included in the Buying Group, and certain data about the IBs' past or planned future orders, and may then offer prices for one or more products or services. In another embodiment, the seller may stipulate certain order quantities in order for Buying Group members to receive the special pricing. In other embodiment, the seller may indicate special payment terms, special Customer Service benefits (such as, for example, a favored customer hotline), or other special advantages to be offered to the Buying Group members, and such advantages may be contingent upon certain order quantities.

FIGS. 21-22 are illustrations of exemplary graphical user interfaces that may be displayed to a seller in order to allow the seller to offer Bid Pricing. FIG. 21 includes the name of the IB 2100 and a matrix of items from other sellers that appear in the pending order. The matrix in FIG. 21 displays information about the IB's pending order, including quantity of cases 2110, quantity of “eaches” 2120, the name assigned to the item by the Order System 2130, the code assigned by the seller to a Comparable item offered by the seller if available 2140, the case price currently offered in the Order System for the item 2150, the “each” price currently offered in the Order System for the item 2160, and the price subtotal for the specified quantities of the item at these prices 2170. FIG. 21 also includes hyperlinks to allow the seller to designate a different substitute item 2140, a Bid Price to be offered in place of the current case price 2150, and/or a Bid Price to be offered in place of the current “each” price 2160. FIG. 21 also includes an option to view a similar matrix listing the seller's own items that are already included in the pending order 2175, an option to view a summary of the bid 2180, and an option to submit the bid 2190. FIG. 22 includes a summary of information about the Bid Set the seller is preparing to offer the IB regarding the pending order, including the total items in the pending order 2200, the total items in the Bid Set 2210, the original invoice total for the entire pending order 2220, the invoice total for the items in the pending order that are represented by the Bid Set 2230, the invoice total for the items in the Bid Set itself, 2240, the savings expressed as a percentage of the entire order that the IB would enjoy by accepting the offered Bid Set 2250, and the savings expressed as a percentage of the Bid Set that the IB would enjoy by accepting the offered Bid Set 2260.

The foregoing method and system are applicable for any type of transaction involving recurring purchases of many items available from multiple sellers. Thus, a method and system for providing an online marketplace for registered buyers making frequently recurring purchases of multiple products or services simultaneously from multiple sellers is disclosed. While described in the context of certain embodiments, those having skill in the art should appreciate that a number of modifications may be made to the described embodiments, and that certain equivalent embodiments, features and items may be substituted, and that all such modifications and equivalents will fall within the scope of this invention.

It will be apparent to one of ordinary skill in the art that aspects of the invention, as described above, may be implemented in many different forms of software, firmware, and hardware in the implementations illustrated in the figures. The actual software code or specialized control hardware used to implement aspects consistent with the invention is not limiting of the invention. Thus, the operation and behavior of the aspects were described without reference to the specific software code—it being understood that a person of ordinary skill in the art would be able to design software and control hardware to implement the aspects based on the description herein. Some of the features identified as being performed by the content host may be performed by the client.

The foregoing description of preferred embodiments of the invention provides illustration and description, but is not intended to be exhaustive or to limit the invention to the precise form disclosed. Modifications and variations are possible in light of the above teachings or may be acquired from practice of the invention. For example, although many of the operations described above were described in a particular order, many of the operations are amenable to being performed simultaneously or in different orders to still achieve the same or equivalent results.

No element, act, or instruction used in the present application should be construed as critical or essential to the invention unless explicitly described as such.

What is claimed:

1. A method and system providing tools that allow a buyer to simultaneously compare and order multiple products, multiple services, or both, made available from multiple sellers.

2. A method and system as in claim 1, where one of said tools allows the buyer and one or more sellers to indicate that they wish to conduct business with each other.

3. A method and system as in claim 1, where one of said tools allows the buyer to view products and services grouped within taxonomic categories specific to the buyer's industry.

4. A method and system as in claim 1, where one of said tools allows the buyer to view a given product or service's comparison data alongside data for comparable products or services from other sellers.

5. A method and system as in claim 1, where one of said tools allows the buyer to take actions on multiple products and services simultaneously.

6. A method and system as in claim 1, where one of said tools allows the buyer to record products and services with specified quantities to a list of regularly purchased items to facilitate future purchases.

7. A method and system as in claim 1, where one of said tools allows the buyer to record products and services with specified quantities to an order form or list of pending purchases.

8. A method and system as in claim 1, where one of said tools executes an action, such as an automatic substitution or a notification to the buyer, when a product or service on a list, such as a list of regularly purchased items or an order form or list of pending purchases, is less competitive than comparable products or services from one or more sellers based on one or more comparison variables.

9. A method and system as in claim 8, where one of said tools allows the buyer to view comparison information for the less competitive product or service alongside similar information for the comparable products or services.

10. A method and system as in claim 1, where one of said tools allows the buyer to search for a product or service and, as a result, view one or more taxonomic categories within which the product or service is categorized.

11. A method and system as in claim 1, where one of said tools allows a buyer to request lower pricing on one or more specific items from one or more sellers, allows a seller to respond to said request, and allows the buyer to view and take action on the seller's response.

12. A method and system as in claim 1, where one of said tools allows the buyer to invite one or more sellers to review the buyer's order form and submit a bid to supply all or a subset of the products or services for a specified price or prices.

13. A method and system as in claim 12, where one of said tools allows a seller to analyze the buyer's order form in order to determine for which set or subset of products or services the seller wishes to place a bid.

14. A method and system as in claim 12, where one of said tools allows a seller to place a bid for a set or subset of products or services listed on the buyer's order form.

15. A method and system as in claim 12, where one of said tools allows the buyer to review bids from sellers, to analyze the effect of different bids on the order, and to select or reject said bids.

16. A method and system as in claim 1, where one of said tools allows the buyer to join a group of other registered buyers in order to receive offers for volume pricing or other advantages from one or more sellers.

17. A method and system as in claim 16, where one of said tools allows a seller to offer volume pricing or other advantages to a group of buyers.

18. A method and system as in claim 1, where one of said tools allows the buyer to submit an order simultaneously to one or more sellers.

19. A method and system as in claim 1, where one of said tools allows a seller to view the buyer's submitted order and to take certain actions on the order.

20. A method and system as in claim 1, where one of said tools allows a seller to receive automatic notification of the buyer's order and have the order information automatically sent to the seller's information system.
